(19) United States
(12) Patent Application Publication
(10) Pub. No.: US 2006/0199137 A1
(43) Pub. Date: Sep. 7, 2006

(54) Orthodontic retainer system with removable retaining wire

(76) Inventors: Norbert Abels, Homburg (DE); Claus-H. Backes, Saarbrucken (DE)

Correspondence Address: RICK D. NYDEGGER;WORKMAN NYDEGGER, 1000 Eagle Gate Tower, 60 East South Temple, Salt Lake City, UT, 84111, US

(21) Appl. No.: 11/072,022

(22) Filed: Mar. 4, 2005

(51) Int. Cl. A61C 3/00

(52) U.S. Cl. 433/11; 433/8

(57) ABSTRACT

Orthodontic retainers and systems include brackets that permit a retaining wire to be selectively attached and removed from a person's teeth without having to remove the brackets. The retainer systems generally include self-ligating brackets having a base, a slot, and at least one protrusion that at least partially bounds a lingual opening of the slot. The protrusion can be connected to an arm on the base. In another embodiment, the protrusion can be a ligating cover hingedly connected to the base. The protrusion allows a retaining wire to be repeatedly and selectively secured and removed from the bracket while maintaining the bracket connected to the patient's tooth. Orthodontic retainer systems can include a kit having two or more self-ligating brackets and one or more retaining wires.

### BACKGROUND OF THE INVENTION

1. The Field of the Invention

The present invention relates to orthodontic retainer systems. More particularly, the present invention is directed to a system of orthodontic brackets and one or more retaining wires being configured such that the retaining wire can be repeatedly and selectively removed for purposes such as cleaning, repositioning the wire or brackets, or other orthodontic or personal purposes.

2. The Relevant Technology

Orthodontics is a specialized field of dentistry that involves the use of various brackets that rely on mechanical forces to urge poorly positioned, or crooked, teeth into correct alignment and orientation. Orthodontics can be used for cosmetic enhancement of teeth, as well as medically necessary movement of teeth to correct overbite and/or overjet. For example, orthodontic treatment can improve a patient's occlusion, or enhanced spatial matching of corresponding teeth.

One example is the use of orthodontic brackets, commonly referred to as “braces”, which are used in combination with one or more arch wires. Orthodontic brackets are small slotted bodies configured for direct attachment to a patient's teeth. Once the brackets are affixed to the patient's teeth, by a bonding agent, such as cement, a curved arch wire is inserted into the slot of each bracket. The arch wire acts as a template or track to guide movement of the teeth into proper alignment. This phase of orthodontia is generally referred to as the movement phase.

After the teeth are in a substantially straight position, the orthodontist typically uses a retainer system to complete the straightening process. This is referred to as the retaining phase. If a retainer system is not used during the retaining phase, the teeth, especially the upper and lower incisors, tend to move back to their former position. Thus, retaining systems are generally applied behind the lower incisors. The patient may be required to wear a retainer system for a number of years to ensure that the roots of the teeth are correctly positioned to minimize the chance of teeth migrating out of alignment.

One type of retainer system is a removable retainer that includes a retaining wire fixedly attached to a bulky dental appliance. The dental appliance is typically molded to shape and fit the palate of the patient's mouth to maintain alignment of the upper teeth. A removable retainer can also be shaped to fit to maintain alignment of the lower teeth. In either embodiment, typically, the retaining wire is attached to the bulky dental appliance and shaped to span a gap between two of the teeth and then wrap around the front of the patient's teeth or gums. The removable retainer may be worn for extended periods of time. However, the bulky dental appliance to which the retaining wire is attached can become uncomfortable after extended use. Furthermore, when significant movement occurs in the upper teeth, it is necessary to remold the dental appliance and retaining wire, which can produce additional cost to the patient. Additionally, depending on the material of the dental appliance, the dental appliance can often break.

Another type of retainer system is a non-removable retainer that includes a wire permanently attached to the lingual surface of the teeth, usually to the canines of the mandible. Alternatively, the wire can be permanently attached to all teeth from canine to canine. Generally, two configurations are typically used by orthodontists. The first configuration includes the ends of a retaining wire being cemented directly to the lingual surface of the teeth. The second configuration comprises the retaining wire being bonded to bands on the patient's teeth. Brackets have typically been avoided for use with permanent retainers because they can cause significant discomfort due to sharp edges and bulkiness. In addition, conventional brackets require wires, ligatures, or elastics in order to maintain the retaining wire in the bracket, which wires, ligatures, or elastics can produce a rough surface against the patient's tongue. In addition, because significant movement is not required during the retaining stage, a retaining wire bonded to the teeth or a band has generally been viewed as sufficient.

However, permanent retaining systems can cause hygienic problems. For example, because the retaining wire is permanently bonded to the patient's teeth, it can become difficult to clean between the patient's teeth. The patient's teeth often become stained with calculus and the patient cannot floss in certain areas that are blocked by the retaining system. There may be certain reasons for a practitioner to desire to remove the permanent retaining system—for example, in cases of professional cleaning, placing a filling or performing other dental procedures, or simply checking the surfaces of the teeth. However, for removable retainers, in order to remove the retaining wire, an orthodontist must break the bonding material between the wire and the teeth or dental appliance, which can be an uncomfortable process. The retaining wire is often bent during this process, rendering it unusable. Similarly, for permanent retainer systems, where the practitioner wishes to reshape the wire to readjust the alignment, the practitioner must often use a completely new wire because the removal process can bend and deform the wire so that it cannot be reused.

### BRIEF SUMMARY OF THE INVENTION

The present invention is related to orthodontic retainer systems having a removable retaining wire and methods for implementing these retainer systems. The systems and methods contemplate use of self-ligating brackets and removable retaining wires. The retaining wire is held in the self-ligating brackets and configured to be selectively removable either by the practitioner (e.g., orthodontist) or by the patient. For example, the patient may desire to clean the retaining wire and/or area around the teeth to which is bonded the self-ligating brackets. The self-ligating brackets also allow the practitioner or patient to remove and replace the retaining wire in the self-ligating brackets and as many times as necessary during the course of the retaining phase of a patient's orthodontic treatment.

Self-ligating brackets generally comprises a bracket base at least partially defining a slot formed therein for receiving a retaining wire. The base can include one or more arms. The self-ligating brackets also include at least one protrusion connected to the base. The protrusion can be any suitable structure connected to the base that selectively retains a retaining wire within the slot formed on the base. Depending on the structure of the protrusion, the slot and retaining wire can be optimally shaped to assist in maintaining the retaining wire therein. For example, the cross-section of the slot and retaining wire can have longer major axis and a smaller minor axis (e.g., rectangular or oblong) so that the shape of the slot further assists in retaining the retaining wire therein.

The slot preferably has a lingual facing opening. The protrusion at least partially bounds the lingual opening of the slot to selectively maintain the retaining wire therein. In one embodiment, one or more protrusions can extend outwardly from the base to at least partially occlude or bound the lingual opening of the slot. In this configuration, the retaining wire can be snap-fit into the slot. The one or more protrusions can slightly flex to allow the retaining wire to be selectively inserted into and removed out of the slot.

In another embodiment, the protrusion can be a ligating cover hingedly connected to the base using any suitable structure such as, but not limited to, film or living hinges, an elongate film hinge, pin hinges, tethers, and the like. Generally, the ligating cover can selectively engage the base to at least partially bound or cover the lingual opening of the slot. In this manner, the ligating cover selectively secures a retaining wire within the slot.

The self-ligating brackets are configured to be bonded at least indirectly to the lingual surface of a patient's tooth. Generally, the self-ligating brackets are low in profile or height to decrease bulkiness and increase comfort to the patient.

Systems of the present invention can include providing orthodontic kits for practitioner use, the orthodontic kit including one or more retaining wires and two or more self-ligating brackets. The kit can further include an orthodontic tool configured to assist the user in removing the retaining wire from the self-ligating brackets. In one embodiment, the one or more retaining wires can be at least partially pre-shaped.

Methods of using the orthodontic retainer systems with removable retaining wires includes (1) placing two or more self-ligating brackets on the lingual surface of two or more teeth; and (2) securing a retaining wire in the slots of the self-ligating brackets. Optionally, the method can further include (3) releasing the retaining wire from the slot of the self-ligating brackets; (4) replacing the retaining wire in the retaining wire slot; and (5) repeating the releasing and replacing steps one or more times. The method can further include applying a dental tool to selectively engage or disengage the ligating cover from the base of the bracket.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an exemplary low-profile self-ligating bracket that may be used in an orthodontic retainer system according to one embodiment of the invention;

FIG. 1B is a cross-sectional view of the self-ligating bracket of FIG. 1A;

FIG. 2 is a perspective view of an orthodontic retainer system that includes a plurality of self-ligating brackets in combination with a retaining wire;

FIG. 3 is a cross sectional view of a variation of the self-ligating bracket of FIGS. 1A and 1B;

FIG. 4A is a cross-sectional view of another embodiment of a self-ligating bracket that may be used in an orthodontic retainer system according to the invention;

FIG. 4B is a cross-sectional view of the self-ligating bracket of FIG. 3A in the closed position;

FIGS. 5 is a cross-sectional view of yet another embodiment of a self-ligating bracket that may be used in an orthodontic retainer system according to the invention;

FIG. 6 is a cross-sectional view of still another embodiment of a self-ligating bracket that may be used in an orthodontic retainer system according to the invention; and

FIG. 7 illustrates an exemplary orthodontic retainer kit according to the invention.

### DETAILED DESCRIPTION OF EXEMPLARY EMBODIMENTS

The present invention is related to orthodontic retainer systems having a removable retaining wire that allows a practitioner such as, but not limited to, an orthodontist, dentist or technician, or a patient to selectively remove and replace only the retaining wire while leaving the other components of the retainer system intact in a patient's mouth. Generally, the present invention provides one or more self-ligating brackets which are directly or indirectly bonded to the patient's teeth. The self-ligating brackets include a protrusion that selectively secures a retaining wire in a slot formed in the base of the bracket. The protrusion is a means for selectively securing and releasing a retaining wire in and from the slot while maintaining the brackets connected to the patient's teeth. Preferably, although not required, the protrusion exerts pressure on the retaining wire so that the retaining wire is substantially fixed in place. As such, the retaining wire is able to transfer the force exerted against it to the tooth, which force acts to maintain alignment and/or move, as the case may be, the teeth associated with the retaining wire.

The brackets of the present invention are broadly categorized as “self-ligating” brackets, which is herein defined as an orthodontic bracket that does not require the use of ligatures (i.e., ties, wires, elastics) to secure a retaining wire thereto. The term “self-ligating bracket” refers to a class of orthodontic brackets that include at least one protrusion designed to selectively retain the retaining wire within a retaining wire slot. Typically, the protrusion at least partially occludes the lingual opening of the slot in order to reliably retain a retaining wire within the slot. The protrusion is generally movable in order to allow selective insertion and removal of a retaining wire into and out of the retaining wire slot. This allows the retaining wire to be removed for, e.g., cleaning or replacement with another wire.

Generally, the present invention contemplates use of both “passive” and “active” self-ligating orthodontic brackets. The term “passive” bracket refers to brackets that only loosely retain the retaining wire therein, such that considerable movement between the retaining wire and base is possible. The term “active” bracket refers to brackets in which the protrusion exerts force onto the retaining wire, resulting in more precise and controlled tooth movement. The latter type bracket is typically preferred in the retainer systems of the present invention. However, the type of bracket will depend on the particular needs specific to each patient and/or the particular orthodontic phase (movement or retaining) being implemented. In some cases, it may be desirable to use a combination of active and passive brackets.

As is known in the dental industry, wires can be applied to brackets in a “passive” position or an “active” position. The “passive” or “active” nature of the wire is determined when the wire is secured to the brackets. “Active” wires are bent to have an inherent spring force or tension in order to encourage the teeth into movement. “Passive” wires generally do not have any force but are rigid enough to maintain the teeth in a particular alignment. Thus, as used herein, the term “arch wire” refers to any elongate and generally arcuate structure that is bent in an active position when placed in brackets. In contrast, the term “retaining wire” refers to any elongate and generally arcuate structure that is bent in a passive position when placed in brackets. Retaining wires can be thicker and stiffer than arch wires. In many cases, retaining wires have a width (i.e., in the occlusal-gingival direction) that is significantly greater than their height (i.e., in the labial-lingual direction). This allows the retaining wire to have increased stiffness while maintaining a lower profile compared to wires having a circular or square cross section. Retaining wires may be made from any generally rigid, yet resilient, material including, but not limited to, metals and plastics.

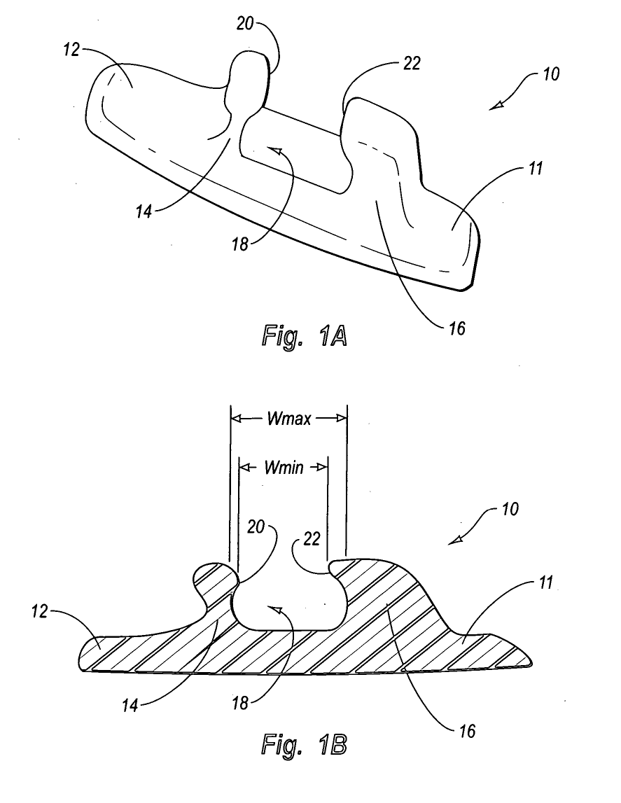

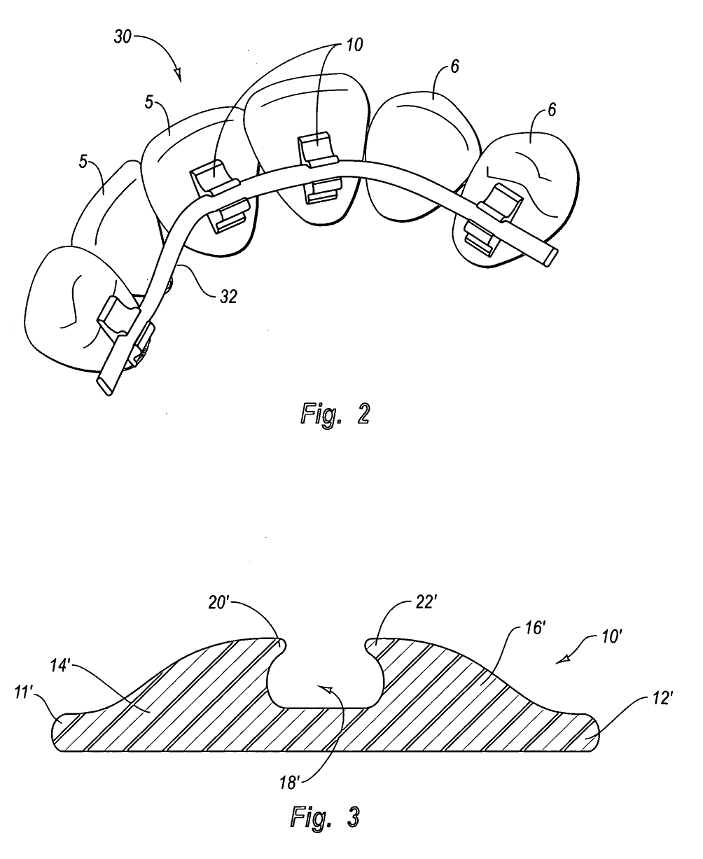

FIGS. 1A and 1B illustrate an exemplary embodiment of a low profile self-ligating bracket 10 that may be used in orthodontic retainer systems according to the invention. Self-ligating bracket 10 includes a base plate 11, a first arm 14, and a second arm 16 that together define a base 12. First arm 14 and second arm 16 together define a retaining wire slot 18 shaped to receive a retaining wire (see FIG. 2). The base plate 11 is advantageously sized so as to cover a substantial portion of a person's tooth in order to provide a large surface area with which to bond the bracket 10 to the tooth.

The retaining wire slot 18 includes a lingual opening through which a retaining wire can be selectively inserted and removed and a pair of opposing side openings through which the retaining wire passes during use. The side openings are therefore approximately parallel to the retaining wire, and the lingual opening is transverse to the side openings and the retaining wire.

First and second arms 14 and 16 further include corresponding first and second protrusions 20 and 22, respectively, which extend over and partially occlude the lingual opening of the retaining wire slot 18 in order to reliably hold a retaining wire within the slot 18 during use. The base plate 11, arms 14 and 16, and protrusions 20 and 22 can be formed integrally from the same material. Alternatively, they may be formed from different materials in one or multiple steps as desired.

One or both of the first and second arms 14 and 16 can be sufficiently flexible in order to allow one or both of first and second protrusions 20 and 22 to spread apart while selectively inserting and removing a retaining wire from the retaining wire slot 18. In this way, first and second arms 14 and 16, in combination with first and second protrusions 20 and 22, cooperate to releasably hold or retain a retaining wire within the slot 18 during use. The first and second protrusions comprise ligating means for selectively holding and releasing a retaining wire.

As shown in FIG. 1B, the retaining wire slot 18 has a maximum width (Wmax) defined by the narrowest portions of first and second arms 14 and 16. The retaining wire slot 18 also has a minimum width (Wmin) defined by the widest portions of first and second arms 14 and 16 in the region of first and second protrusions 20 and 22. In this way, the lingual opening of the retaining wire slot 18 is smaller than the interior of the slot 18 (i.e., because the protrusions 20 and 22 partially bound or occlude the lingual opening). The minimum width (Wmin) of the retainer slot 18 can be configured to be large enough for a retaining wire to be disposed therethrough (see FIG. 2), but small enough to prevent the retaining wire from. inadvertently becoming dislodged from the slot 18.

In order to reduce relative movement between the bracket 10 and a retaining wire, the retaining wire slot 18 is advantageously configured to have a non-circular cross-section. That is, as shown in FIGS. 1A and 1B, retaining wire slot 18 can have a substantially oval or ellipsoidal cross-section. The retaining wire (see FIG. 2) can advantageously have a substantially similar configuration in order to substantially conform to the shape of the retaining wire slot 18 so as to reduce relative movement between the retaining wire and bracket 10. It will be appreciated that this embodiment is merely illustrative, and other cross-sectional shapes of the slot and corresponding retaining wire may also work, such as, but not limited to, square, circular, hemispherical, oval, and triangular.

It should be understood that the height and thickness of first and second arms 14 and 16, as well as the width and thickness of first and second protrusions 20 and 22, are merely illustrative. Any desired combination of height, width, thickness or flexibility of arms and protrusions is within the scope of the invention in order to provide a desired mechanism for securely, yet releasably, holding a retaining wire within a retaining wire slot associated with the self-ligating bracket. For example, one or both of the arms may be thicker to the point of being essentially rigid. In such a case, one or more protrusions may be provided that flex independently of the arm to which each is attached. One or both arms may substantially or wholly cover the base plate so that one or both “arms” are essentially indistinguishable from the base plate (e.g, FIG. 3). In such a case, the bracket will include one or more flexible protrusions able to spread open sufficiently, or otherwise able to move aside, so as to permit selective insertion and removal of the retaining wire relative to the slot.

FIG. 2 illustrates an orthodontic retainer system 30 used to maintain a desired orientation of a person's teeth following an orthodontic procedure. The retainer system 30 includes a plurality (e.g., four) self-ligating brackets 10 attached to lingual surfaces of a plurality (e.g., four) of a person's teeth. Each self-ligating bracket 10 is attached to the lingual surface 6 of a respective tooth 5. The brackets 10 can be attached to the teeth using bonding adhesives or cements known in the art. The bonding adhesives or cements may be light cured, chemically cured, or dual cured.

Disposed within the retaining wire slot 18 of each bracket 10 is a retaining wire 32 sized and shaped to fit within the slot 18. The protrusions 20 and 22 are such that the retaining wire 32 can engage the slot 18 in a snap-fit configuration. According to the embodiment shown, the retaining wire 32 has curved ends edges for increased comfort and ease of inserting the retaining wire into slot 18. The retaining wire 32 also has a cross section that substantially corresponds to the cross section of the retaining wire slot 18 in order to restrict relative movement between the bracket 10 and retaining wire 18. This helps apply maximum force to maintain the person's teeth in a desired orientation.

By placing the retaining system 30 on the lingual surface 6 of the patient's teeth 5, the components are substantially hidden from view to provide a more aesthetically pleasing appearance. Nevertheless, it is certainly within the scope of the invention for self-ligating brackets according to the invention to be alternatively attached to labial surfaces 7 of the person's teeth 5. In such cases, the retaining wire slot will have a “labial opening” rather than a lingual opening.

FIG. 3 depicts an alternative embodiment of an orthodontic bracket 10′ that includes a base plate 11′ and first and second arms 14′ and 16′ that define a retaining wire slot 18′. In this embodiment, first and second arms 14′ and 16′ merge together with the base plate 11′ so as to be essentially part of the base plate 11′ and so as to be substantially rigid. As a result, one or both of first and second protrusions 20′ and 22′ may be flexible in order to permit selective insertion and removal of a retaining wire into and from the slot 18′. Alternatively, the retaining wire (not shown) may have flexible (e.g., elastomeric) outer edges that permit the edges of the wire to flex sufficiently to allow selective insertion and removal of the retaining wire relative to the bracket 10′.

The self-ligating brackets used in retainer systems according to the invention are advantageously low profile so as to maximize patient comfort. This frees up space inside the patient's mouth to make talking, eating and normal activity more comfortable and enjoyable. The self-ligating brackets preferably have a height in a range of about 1.5 mm to about 5 mm, more preferably in range of about 1.75 mm to about 4 mm, and most preferably in a range of about 2 mm to about 3 mm. In one presently preferred embodiment, the height of the self-ligating bracket is about 2.5 mm. However, brackets of any size may be suitable for use with the orthodontic methods and systems of the present invention depending on the size and shape of a person's teeth, dental arch and mouth.

As mentioned above, the orthodontic process generally includes a movement phase, and a retaining phase. In some cases, a person's teeth will be substantially straight such that the patient will only require the retaining phase of orthodontia. As used herein, the term “retaining wire” refers to a wire that is suitable for use during the retaining phase of the orthodontic process. Retaining wires are configured to retain the teeth in alignment. In general, retaining wires are bent passively. In addition, retaining wires can generally be thicker than arch-wires in order to reduce the amount of movement of the brackets along the retaining wires. The retaining wires can further be configured with a non-circular (i.e., flattened) cross-section in order to provide additional rigidity without adding additional thickness or height.

An exemplary method for creating a retaining system using brackets and retaining wires of the present invention includes selecting two or more brackets and bonding them at least indirectly to the lingual or labial surfaces of one or more of a patient's teeth. The practitioner shapes a retaining wire in a desired configuration corresponding to a desired permanent tooth alignment or orientation. The practitioner then places the shaped retaining wire into the retaining slots of the two or more brackets attached to the teeth. One or more protrusions at least partially occlude the opening of the retaining wire slot in order to reliably hold the retaining wire in the slot.

Methods of the present invention further include optionally releasing the retaining wire from bracket slots when it is desired to remove the retaining wire, e.g., by a dental practitioner or user to allow for inspection, cleaning, flossing, or performing dental work on the now-exposed area of the teeth. The practitioner or patient can also clean the retaining wire, if desired. Increased access to the patient's teeth by enabling the practitioner or patient to remove the retaining wire provides for better dental hygiene for a patient, especially where it is contemplated that the patient will use the retaining system for an extended period of time.

When the practitioner or patient is finished with the purpose for which the retaining wire was removed, the practitioner or patient can then replace the retaining wire. This follows much the same steps outlined above for initially disposing the retaining wire in the brackets including placing the retaining wire in the brackets so that the protrusion secures the retaining wire in the slot. Removing the retaining wire from the bracket and replacing the retaining wire can be repeated as many times as necessary.

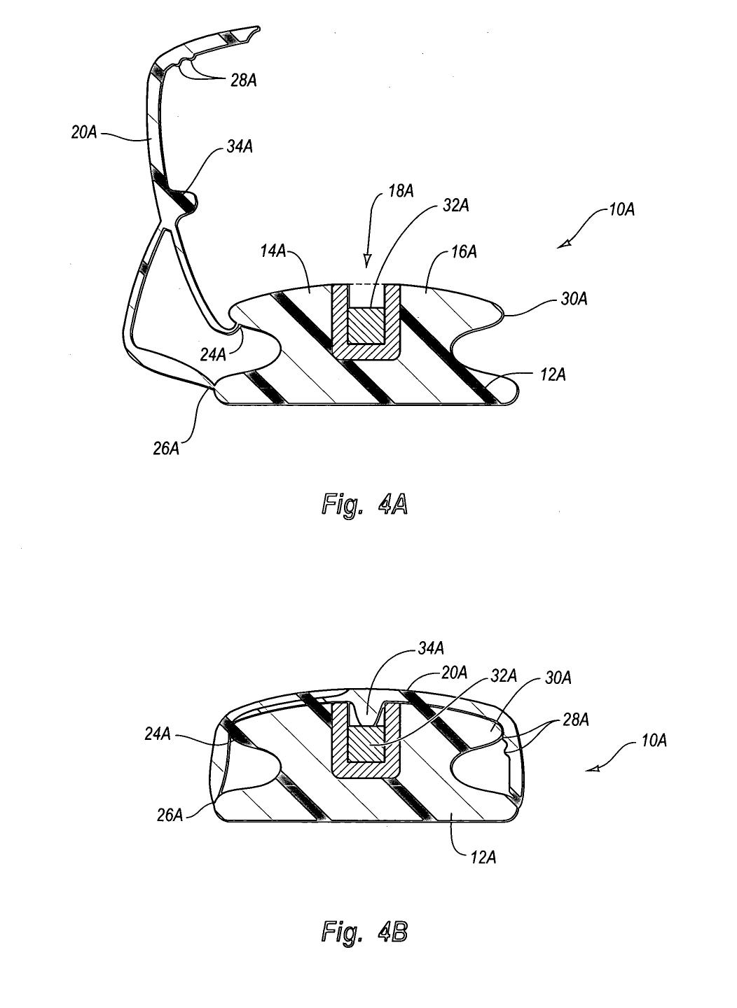

With reference to FIGS. 4A and 4B, another embodiment of a self-ligating. bracket similar to bracket 10 and 10′. As such, like elements will be referred to with like reference numerals. In this embodiment, bracket 10A includes base 12A having base plate 111A and arms 14A and 16A. Bracket 10A illustrates that protrusion 20 or 22 of FIG. 1A and 1B can be a ligating cover 20A that is connected to base 12A. Ligating cover 20A is a configured to selectively occlude or bound the lingual opening of slot 18A. The ligating cover 20A thus ligates or holds in place the retaining wire 32A within slot 18A. Ligating cover 20A is another embodiment of means for selectively securing and releasing a retaining wire 32 in and from the slot 18 while maintaining the brackets 10A connected to the patient's teeth.

Ligating cover 20A is connected to arm 14A by a hinge element 24A and connected to base place 11A by hinge element 26A and can comprise the same material. The hinge elements 24A, 26A can be a film hinge comprising an area or region of locally reduced cross-sectional thickness in order to provide increased flexibility in the hinge region. The base 12A and ligating cover 20A can be molded, such as by injection molding, in a single molding step to yield an integral, one-piece orthodontic bracket 10A. Accordingly, the film hinges 24A, 26A provides a center point or line of rotation about which the ligating cover 20A can be rotated back and forth between an open position, in which the retaining wire slot 18A is completely open (FIG. 4A), and a closed or locked position, in which the retaining wire slot 18A is completely enclosed in order to provide ligating of a retaining wire disposed therein (FIG. 4B).

A plurality of locking notches 28A formed in ligating cover 20A can engage protrusion 30A on arm 16A. A bearing or holding cam 34A can extend downwardly from the ligating cover 20A and partially into the retaining wire slot 18A when the ligating cover 20A is in a closed or locked position (FIG. 4B) in order to apply direct pressure to the retaining wire 32A and thereby provide active ligation. It will be appreciated that other locking or securing structures can be used to selectively secure ligating cover 20A in place. In one embodiment, ligating cover 20A can be attached to base 12A using a spring mechanism. Details of how this is accomplished are disclosed in U.S. Pat. No. 6,695,612, filed Aug. 15, 2002, the disclosure of which is hereby incorporated by reference.

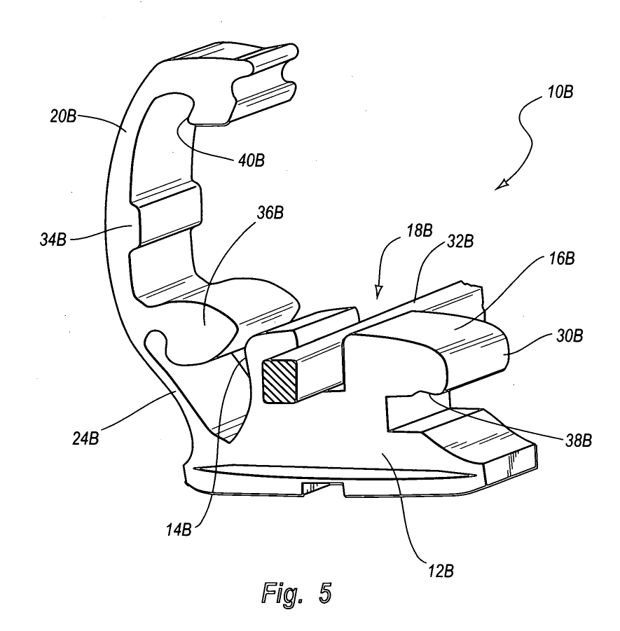

With reference to FIG. 5, another embodiment of orthodontic bracket 10B is shown that is similar to bracket 10A. As such, like elements will be referred to with like reference numerals. In this embodiment, ligating cover 20B is hingedly connected to the base 12B only at base plate 11B by an elongated film hinge 24B that bends along substantially its entire length rather than at a single point or line. The elongated film hinge 24B preferably has a length and thickness that are selected so that the hinge 24B has a desired level of strength, elasticity, flexibility and toughness. Optionally, a cam structure 36B interacts with the elongated film hinge 24B to provide a curved surface that helps ensure that the elongated film hinge 24B bends gradually over its entire length rather than abruptly at any specific locale. A keyway 318B formed in arm 16B and a tongue 40B formed on ligating cover 20B illustrate another embodiment of a structure for locking or securing ligating cover 20B in place.

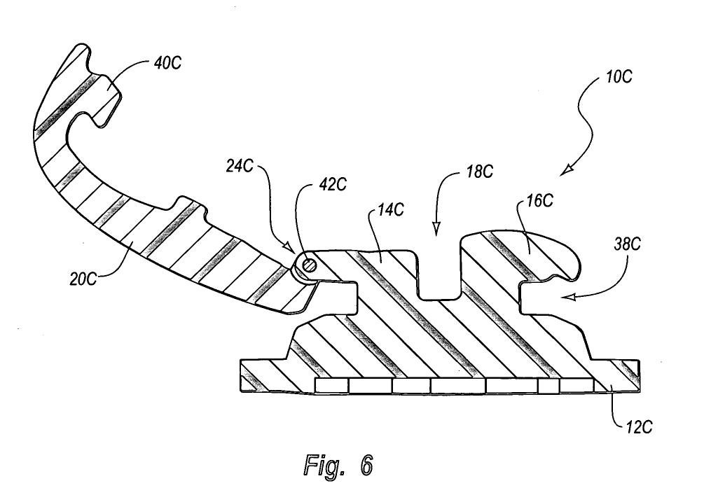

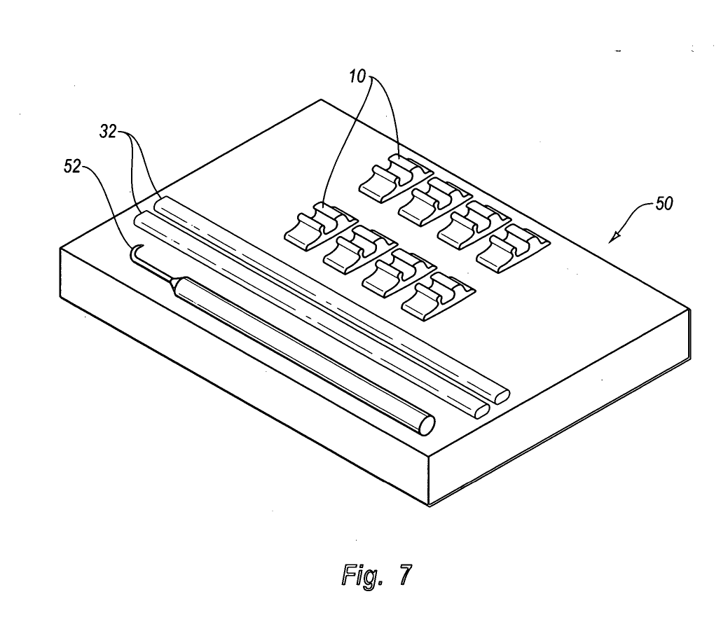

FIG. 6 depicts an orthodontic bracket 10C similar to brackets 10A and 10B where like elements are referred to with like numerals. In this embodiment, arm 14C and ligating cover 20C are formed separately and then hingedly attached together by means of a conventional hinge 24C, such as by means of a hinge pin 42C passing through corresponding recesses within the arm 14C and ligating cover 20C.

The above description relating to, FIGS. 4A, 4B, 5 and 6 illustrates embodiments of brackets and ligating protrusions being hingedly connected. As used herein, the term “hingedly connected” refers to any structure which maintains the base and ligating protrusion such that they can be selectively opened and closed in relation to each other. In these embodiments, the protrusion is generally a ligating cover hingedly connected to the base. Such structures for forming a hinge connection include, but are not limited to, film or living hinges, elongate film hinges, pin hinges, tethers and the like. Preferably, the structure that connects the base and ligating cover of the brackets can be repeatedly flexed so as to allow a practitioner or patient to repeatedly remove and replace the ligating cover onto the base of the bracket while minimizing the likelihood that the ligating cover will become separated from the rest of the bracket.

In the embodiments where the ligating protrusion is a ligating cover, methods can further include selectively securing the ligating cover over the lingual opening of the retaining wire slot so as to retain the retaining wire therein. This can include selectively engaging the ligating cover with the corresponding structures in the base to place the ligating cover in the closed position. Selectively removing the retaining wire can also include disengaging the ligating cover from covering the lingual opening of the slot, wherein the base and ligating cover remain connected even when the retaining wire is released.

In embodiments where the brackets having ligating covers are placed on a patient's bottom teeth, the protrusion is generally positioned so that the ligating cover opens downwardly. That is, the clasp or latch of the ligating cover is positioned toward the top of the teeth. It will also be appreciated that in embodiments where the brackets are placed on the patient's top teeth, the ligating covers will generally be positioned so that they open upwardly with the clasp or latch of the ligating cover positioned toward the bottom of the teeth. This orientation of ligating covers is primarily for convenience of the patient. However, it will be appreciated that brackets can be placed on a patient's teeth in any orientation so long as it is possible for the practitioner or patient to access the latch or clasp.

It will be appreciated that the ligating covers are easily opened and closed without the need for special tools or complicated techniques. For example, the ligating cover can easily be opened by means of a person's nail or an orthodontic tool. As such, a patient can easily remove the retaining wire from one or more brackets in an orthodontic retaining assembly even in embodiments where the ligating protrusion is a ligating cover hingedly attached to the base.

Various other self-ligating bracket designs are disclosed in U.S. Pat. No. 6,607,383; U.S. application Ser. No. 09/914,737, filed Aug. 29, 2001, abandoned; and U.S. application Ser. No. 09/953,400, filed Sep. 12, 2001. For purposes of disclosing exemplary orthodontic self-ligating bracket designs, the foregoing U.S. applications and patent are incorporated by reference.

The retaining slots discussed above may serve the dual purpose of receiving arch wires. In this manner, in one embodiment, the brackets of the present invention could be used during all phases of orthodontia. For example, an orthodontist may use the brackets with arch wires to move the teeth into their final position. This may include using additional ligatures in addition to the protrusion. Then, the orthodontist may use the same brackets in a non-permanent manner to hold a retaining wire so, that the patient can selectively and repeatedly. remove the retaining wire as needed. This prevents the need to replace the brackets with another set of brackets between phases, reducing the: time and cost of implementing orthodontia.

Systems of the present invention thus comprise-two or more brackets with at least one retaining wire. The systems can be provided throughout all phases of orthodontia, including, but not limited to, manufacture and transportation and to finally be implemented and located on in a patient's mouth. In one embodiment, with reference to FIG. 5, retaining systems can be provided in a kit assembly 50 to provide added convenience to the practitioner. For example, a kit 50 may include two or more brackets 10 and one or more retaining wires 32. The kit 50 may include brackets having the same configuration, or brackets having different configurations. For example, the kit may include brackets having lower profiles and having higher profiles so that the practitioner may choose the particular brackets depending on the size of the patient's mouth and teeth. The kit 50 may also include a sufficient number of brackets and retaining wires to implement a retaining assembly on both the patient's upper and lower sets of teeth.

To conserve space in the kit, the retaining wire may be provided straight. However, the retaining wire may also be assembled pre-curved; although it will be appreciated that a practitioner will likely be required to adjust the curvature of the retaining wire specific to each patient's needs. In addition, a kit 50 can include a simple dental tool 52 which can be sent home with the patient to assist the patient in opening the brackets to allow the retaining wire to be removed. The kit 50 can also include, although not shown, any other components which may be involved during the process of implementing the retainer systems of the present invention including but not limited to, containers of bonding agent for bonding the brackets to the tooth, bands for placing over the teeth; curing lights for curing the bonding agent or retaining wire, and the like.

The materials of the brackets of the present invention will now be discussed in detail. The base of the brackets of the invention generally provides the bulk strength of the bracket. The base can be made from any suitable material, or groups of materials, having, desired properties, such as strength, rigidity, durability, moldability, or machinability. In contrast, the ligating protrusion provides a mechanism for allowing a retaining wire in the bracket to be repeatedly removed and replaced in the bracket. Thus, it is desirable that the ligating protrusion be somehow connected to the base and, in some cases, be constructed of a material which allows repeated flexing. In addition, it is desirable that the ligating protrusion maintain a low profile so that it does not cause the patient discomfort. The ligating protrusion can thus be made from the same or different materials than the base with the material having the same properties or different properties.

Examples of materials include, but are not limited to, a wide variety of polymeric materials (including both thermoset and thermoplastic polymers), metals, metal alloys, ceramics, and combinations thereof. Suitable polymers broadly include thermoplastic and thermoset materials or those materials which have suitable properties of moldability and hardenability. In general, the base comprises polymers that result in harder plastics in order to provide a rigid, stable base. Softer, more flexible polymers such as polyethylene and polypropylene may be suitably employed for the ligating protrusions, particularly where it is desired for the ligating cover to have more resiliency or flexibility.

Examples of polymeric materials that can be included in the bracket include, but are not limited to, more crystalline polyamides, acetal polymers, urethanes, polyetherimides, polycarbonates, polysulphones, polyethersulphones, polyethylene teraphthalate, polyethylene teraphthalate glycol, acrylics, polyarylether ketones, polyethylene, polypropylene, polyaramides, polyesters, polyarylamides, and combinations thereof. In one embodiment, crystalline polymers are desirable to construct the base. Crystalline polymers can further be blended with one or more amorphous polymers.

Ceramic material can be, but is not limited to, metal oxides, metal carbides, and metal nitrides such as, but not limited to, zirconium oxide, aluminum oxide, magnesium oxide and/or silicon oxide or mixtures thereof. Examples of metals and metal alloys include, but are not limited to, stainless steel, stainless steel alloys, titanium, and nickel-titanium alloys.

The materials used to form the brackets can be formed and/or brought together using any desired process. In some embodiments, the bracket can be made from a single material in a single piece, which may be more cost effective from the standpoint of manufacturing costs, as well as providing greater ease of use. In the case where a more rigid plastic is used for the base, and a more flexible plastic is used for the ligating protrusion or ligating cover, it will typically be advantageous to mold the base separate from the ligating protrusion or ligating cover and then thermally fuse them together to form a single, integrally connected bracket. This procedure is sometimes referred to as “two-color molding”, which refers to the fact that two different plastic materials are molded or fused together to form a single integral, or one-piece, article of manufacture. This process is especially suitable where two or more different polymeric materials or used to form different regions or segments of the bracket. According to another embodiment, the base can be formed initially, followed by formation of the ligating protrusion or ligating cover thereto, e.g., in embodiments where the base and ligating protrusion or cover are made from different materials.

Plastics and ceramics can be reinforced with suitable materials to strengthen the resulting bracket, such as, but not limited to, TFG Type 3 glass (“c-glass”). The bracket may comprise one or more materials that are partially or wholly for aesthetic purposes (e.g., color, shape, etc.). For example, the brackets can include a coating which reduces staining or abrasion. Additionally, portions of the base can be made from a material that has greater chemical and/or mechanical bonding with a substrate than other areas of the bracket.

The retaining wire can be formed from any suitable material which has sufficient flexibility and strength to allow a practitioner to shape the wire into a desired alignment and then to suitably maintain the patient's teeth into the desired alignment during the alignment phase. Retaining wires can be constructed from suitable materials such as, but not limited to, metals, polymers, light-curable polymers, glass-filled polymers, and the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An orthodontic bracket configured to be used with a wire, wherein the wire is an arch wire or a retaining wire, the bracket comprising:
a base at least partially defining a slot configured to receive a wire therein, the slot having a lingual opening through which a wire can be selectively inserted and removed; and
one or more protrusions connected to the base and partially occluding the lingual opening of the slot, the lingual opening being able to temporarily widen to allow a wire to be selectively secured and released in and from the slot in a snap-fit configuration.

2. The orthodontic bracket as recited in claim 1, the base further comprising one or more arms, wherein one of the one or more arms is connected to one of the one or more protrusions.

3. The orthodontic bracket as recited in -claim 2, wherein at least one of the arms is configured to flex when a wire is being selectively inserted and removed through the lingual opening.

4. The orthodontic bracket as recited in claim 3, wherein the arm that is able to flex has a cross sectional thickness and/or is constructed of a flexible material that allows the arm to flex.

5. The orthodontic bracket as recited in claim 1, wherein the bracket has a height from about 1.5 mm to about 5 mm.

6. The orthodontic bracket as recited in claim 1, wherein the bracket has a height from about 1.75 mm to about 4 mm.

7. The orthodontic bracket as recited in claim 1, wherein the bracket has a height from about 2 mm to about 3 mm.

8. The orthodontic bracket as recited in claim 1, wherein the slot has a non-circular cross-section.

9. An orthodontic retainer system comprising:
a retaining wire configured to be bent passively in order to retain a person's teeth in a desired orientation over time; and
at least two self-ligating brackets configured to be separately bonded to a respective one of a person's teeth, each self-ligating bracket comprising:
a base at least partially defining a slot configured to receive the retaining wire, the slot having a lingual opening through which the retaining wire can be selectively inserted and removed; and
means for selectively securing and releasing the retaining wire in and from the slot while maintaining the at least two self-ligating brackets connected to at least two teeth.

10. The orthodontic retainer system as recited in claim 9, wherein the means for selectively securing and releasing the retaining wire in and from the slot while maintaining the at least two self-ligating brackets connected to at least two teeth comprises a first protrusion connected to the base and at least partially occluding the lingual opening of the slot.

11. The orthodontic retainer system as recited in claim 10, wherein the first protrusion at least partially defines a minimum width of the lingual opening that is smaller than a maximum width of the slot.

12. The orthodontic retainer system as recited in claim 11, the base further comprising a first arm, wherein the first protrusion is connected to the first arm, wherein the first arm is configured to slightly flex when the retaining wire is selectively inserted and removed through the lingual opening during use.

13. The orthodontic retainer system as recited in claim 11, wherein the first protrusion is constructed of a flexible material so that the first protrusion is able to flex when the retaining wire is selectively inserted and removed through the lingual opening.

14. The orthodontic retainer system as recited in claim 10, wherein the first protrusion is a ligation cover hingedly connected to the base, the ligating cover configured to be selectively moved between an open position, in which the lingual opening of the slot is completely unoccluded by the ligation cover, and a closed position, in which the lingual opening of the slot is at least partially occluded by the ligation cover.

15. The orthodontic retainer system as recited in claim 14, wherein the ligation cover is hingedly connected to the base via an integral film hinge.

16. The orthodontic retainer system as recited in claim 14, wherein the ligating cover is hingedly connected to the base via a hinge pin.

17. The orthodontic retainer system as recited in claim 9, further comprising an orthodontic tool configured to assist a user in removing the retaining wire from the slot of the at least two self-ligating brackets.

18. An orthodontic retainer system comprising:
a first retaining wire configured to be bent passively in order to retain a person's teeth in a desired orientation over time;
at least two self-ligating brackets configured to be bonded to at least two teeth, each self-ligating bracket comprising:
a base at least partially defining a slot configured to receive the first retaining wire, the slot having a lingual opening through which the retaining wire can be selectively inserted and removed; and
a protrusion connected to the base and configured to selectively secure and release the first retaining wire in and from the slot while the at least two self-ligating brackets are connected to at least two teeth, wherein the protrusion at least partially defines a minimum width of the lingual opening that is smaller than a maximum width of the slot.

19. The orthodontic retainer system as recited in claim 18, the base further comprising an arm, wherein the protrusion is connected to the arm.

20. A method for releasably attaching a retainer wire to a person's teeth, the method comprising:
providing a retaining wire that is bent passively in order to retain a person's teeth in a desired orientation over time;
bonding two or more self-ligating brackets on lingual surfaces of two or more teeth of a patient; and
removably securing the retaining wire in a slot of each self-ligating bracket in a manner that permits selective release of the retaining wire from the slot of each self-ligating bracket while the self-ligating brackets remain bonded to the teeth of the patient.

21. The method as recited in claim 20, further comprising selectively releasing the first retaining wire from the slot of each self-ligating bracket.

22. The method as recited in claim 21, further comprising replacing the retaining wire back into the slot of each self-ligating bracket.

23. The method as recited in claim 21, further comprising replacing the retaining wire with a new retaining wire and removably securing the new retaining wire in a slot of each self-ligating bracket.
